(19) United States
(12) Patent Application Publication
(10) Pub. No.: US 2024/0193796 A1
(43) Pub. Date: Jun. 13, 2024

(54) PREDICTION SYSTEM, PREDICTION APPARATUS, AND PREDICTION METHOD

(71) Applicant: NEC Corporation, Tokyo (JP)

(72) Inventor: Katsuhiro YUTANI, Tokyo (JP)

(73) Assignee: NEC Corporation, Tokyo (JP)

(21) Appl. No.: 18/528,447

(22) Filed: Dec. 4, 2023

(30) Foreign Application Priority Data
Dec. 9, 2022 (JP) 2022-197374

(51) Int. Cl. G06T 7/246; G06T 7/521; G06T 7/564

(52) U.S. Cl. CPC G06T 7/251; G06T 7/521; G06T 7/564; G06T 2207/10028

(57) ABSTRACT

An acquisition means repeatedly acquires three-dimensional data of a monitoring target surface on a time axis. A deformation detection means detects, based on a plurality of pieces of the three-dimensional data, a first deformation occurring at a first time, and a second deformation occurring at a position different from an occurrence position of the first deformation at a second time being after the first time. A deformation prediction means predicts, based on a detection result by the deformation detection means, that a third deformation may occur in a future at a position different from occurrence positions of the first deformation and the second deformation.

### INCORPORATION BY REFERENCE

This application is based upon and claims the benefit of priority from Japanese patent application No. 2022-197374, filed on Dec. 9, 2022, the disclosure of which is incorporated herein in its entirety by reference.

### TECHNICAL FIELD

The present invention relates to a prediction system, a prediction apparatus, and a prediction method.

### BACKGROUND ART

Patent Literature 1 (Japanese Unexamined Patent Application Publication No. 2015-42956) discloses a technique of detecting a deformation of a slope by scanning the slope of a river bank by using a laser scanner.

However, in Patent Literature 1, it is not possible to predict a deformation of a slope.

### SUMMARY

An example object of the present disclosure is to provide a technique for predicting a deformation of a monitoring target surface.

In a first example aspect of the present disclosure, a prediction system includes:
an acquisition means for repeatedly acquiring three-dimensional data of a monitoring target surface on a time axis;
a deformation detection means for detecting, based on a plurality of pieces of the three-dimensional data, a first deformation occurring at a first time, and a second deformation occurring at a position different from an occurrence position of the first deformation at a second time being after the first time; and
a deformation prediction means for predicting, based on a detection result by the deformation detection means, that a third deformation may occur in a future at a position different from occurrence positions of the first deformation and the second deformation.

In a second example aspect of the present disclosure, a prediction apparatus includes:
an acquisition means for repeatedly acquiring three-dimensional data of a monitoring target surface on a time axis;
a deformation detection means for detecting, based on a plurality of pieces of the three-dimensional data, a first deformation occurring at a first time, and a second deformation occurring at a position different from an occurrence position of the first deformation at a second time being after the first time; and
a deformation prediction means for predicting, based on a detection result by the deformation detection means, that a third deformation may occur in a future at a position different from occurrence positions of the first deformation and the second deformation.

In a third example aspect of the present disclosure, a prediction method includes,
by a computer executing:
an acquisition step of repeatedly acquiring three-dimensional data of a monitoring target surface on a time axis;
a deformation detection step of detecting, based on a plurality of pieces of the three-dimensional data, a first deformation occurring at a first time, and a second deformation occurring at a position different from an occurrence position of the first deformation at a second time being after the first time; and
a deformation prediction step of predicting, based on a detection result in the deformation detection step, that a third deformation may occur in a future at a position different from occurrence positions of the first deformation and the second deformation.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a functional block diagram of a prediction system;

FIG. 2 is a functional block diagram of a prediction apparatus;

FIG. 3 is an elevation distribution diagram at a first time;

FIG. 4 is an elevation distribution diagram at a second time;

FIG. 5 is an image illustrating a deformation prediction result; and

FIG. 6 is a control flow of the prediction apparatus.

### EXAMPLE EMBODIMENT

### Outline of Present Disclosure

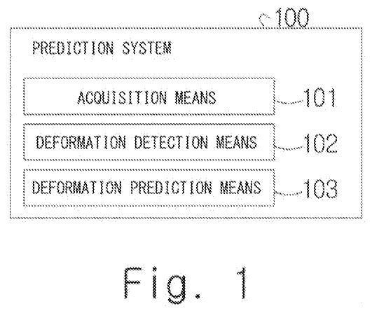

Hereinafter, an outline of the present disclosure will be described with reference to FIG. 1.

FIG. 1 is a functional block diagram of a prediction system 100. As illustrated in FIG. 1, the prediction system 100 includes an acquisition means 101, a deformation detection means 102, and a deformation prediction means 103.

The acquisition means 101 repeatedly acquires three-dimensional data of a monitoring target surface on a time axis.

The deformation detection means 102 detects, based on a plurality of pieces of the three-dimensional data, a first deformation occurring at a first time, and a second deformation occurring at a position different from an occurrence position of the first deformation at a second time being after the first time.

The deformation prediction means 103 predicts, based on a detection result by the deformation detection means 102, that a third deformation will occur in a future at a position different from occurrence positions of the first deformation and the second deformation.

According to the above configuration, it is possible to predict in advance a deformation that may occur in a monitoring target surface in the future.

### FIRST EXAMPLE EMBODIMENT

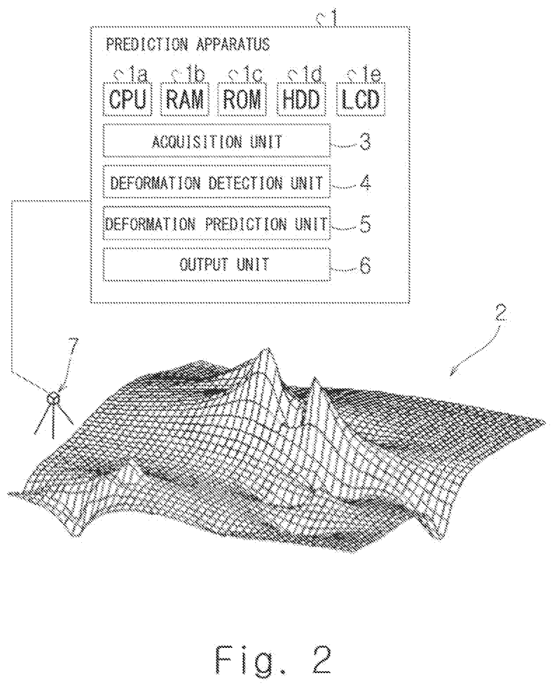

Hereinafter, a first example embodiment of the present disclosure will be described with reference to FIGS. 2 to 6.

FIG. 2 illustrates a functional block diagram of a prediction apparatus 1. The prediction apparatus 1 is an apparatus that monitors ground 2 and thereby predicts in advance a deformation that may occur in the ground 2 in a future.

Herein, the ground 2 means a surface of land. Therefore, the ground 2 includes not only a surface of a natural object but also a surface of an artifact. The artifact is typically a paved road surface. In the present example embodiment, the ground 2 is one specific example of a monitoring target surface. However, the monitoring target surface may be a wall surface of a building. A deformation on the ground 2 includes a depression, an elevation, and a crack on the ground 2, and another change in a shape of the ground 2.

In the present example embodiment, the ground 2 to be monitored by the prediction apparatus 1 is a ground surface that may be affected by performing underground excavation using a shield machine. In other words, as the underground excavation by the shield machine progresses, it is assumed that deformations occur in such a way as to be in series on the ground 2. When an attempt is made to deal with a deformation later after the deformation on the ground 2 occurs, work such as paving work and soil improvement work being already performed on the ground 2 is wasted, and work efficiency is significantly deteriorated.

Therefore, by predicting in advance a deformation that may occur in the ground 2 in the future by using the prediction apparatus 1, the paving work and the soil improvement work may be appropriately postponed, and work necessary for eliminating the deformation may be planned and executed.

Therefore, as illustrated in FIG. 2, the prediction apparatus 1 includes a central processing unit (CPU) la as a central arithmetic processor, a random access memory (RAM) 1b being read-write free, and a read only memory (ROM) 1_{c} dedicated to read-only. The prediction apparatus 1 further includes a hard disk drive (HDD) 1d being an external storage apparatus, and a liquid crystal display (LCD) 1e as a display means.

Then, the CPU 1a reads and executes a control program stored in the ROM 1c or the HDD 1d. As a result, the control program causes hardware such as the CPU 1a to function as an acquisition unit 3, a deformation detection unit 4, a deformation prediction unit 5, and an output unit 6.

The acquisition unit 3 is one specific example of an acquisition means. The acquisition unit 3 repeatedly acquires three-dimensional data of the ground 2 from a three-dimensional LiDAR scanner 7 on a time axis. The three-dimensional LiDAR scanner 7 generates three-dimensional data of the ground 2 by emitting laser light in a wide range toward the ground 2 and measuring a time required for receiving reflected light of the emitted laser light (so-called a time of flight (ToF) method). Alternatively, the three-dimensional LiDAR scanner 7 generates three-dimensional data of the ground 2, based on a frequency difference between the laser light and the reflected light (so-called a frequency modulated continuous wave (FMCW) method). Alternatively, the three-dimensional LiDAR scanner 7 generates three-dimensional data of the ground 2, based on a phase difference between the laser light and the reflected light (so-called an indirect ToF method). The three-dimensional data generated by the three-dimensional LiDAR scanner 7 are typically point cloud data. The point cloud data are constituted by a plurality of pieces of point data. Each piece of point data includes a piece of coordinate data represented in an XYZ coordinate system.

The acquisition unit 3 acquires three-dimensional data of the ground 2 at a predetermined interval. The predetermined interval is typically from five minutes to ten minutes. However, instead of this, the acquisition unit 3 may irregularly acquire three-dimensional data of the ground 2. The acquisition unit 3 stores the acquired three-dimensional data in the HDD 1d. As a result, a large amount of three-dimensional data of the ground 2 is accumulated in the HDD 1d.

The deformation detection unit 4 is one specific example of a deformation detection means. The deformation detection unit 4 detects a deformation in the ground 2, based on a plurality of pieces of the three-dimensional data stored in the HDD 1d. The deformation prediction unit 5 is one specific example of a deformation prediction means. The deformation prediction unit 5 predicts, based on a detection result by the deformation detection unit 4, a deformation that may occur on the ground 2 in the future. The output unit 6 outputs a prediction result by the deformation prediction unit 5 to the LCD 1e in an image format.

Hereinafter, the deformation detection unit 4, the deformation prediction unit 5, and the output unit 6 will be described in detail.

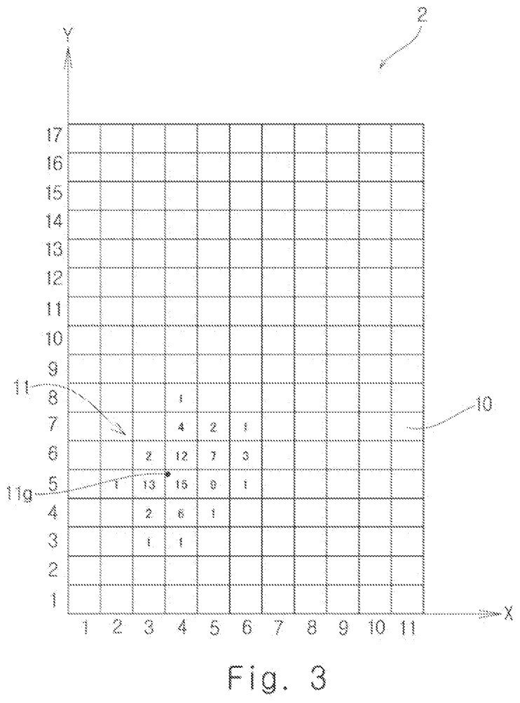

As illustrated in FIG. 3, the deformation detection unit 4 divides the ground 2 into lattice shapes in a plan view. As a result, the ground 2 becomes a set of a plurality of cells 10. Each cell 10 is typically a 30 centimeter square. A size of each cell 10 may typically be determined in such a way that at least one piece of point data associates with respect to each cell 10.

Next, the deformation detection unit 4 acquires a Z coordinate of each cell 10, based on three-dimensional data acquired by the acquisition unit 3 at a time t0. When only one piece of point data associates to a certain cell 10, the Z coordinate of the one piece of point data is substituted into the Z coordinate of the cell 10. On the other hand, when a plurality of pieces of point data associate to a certain cell 10, a statistical value (e.g., an average value, a median value, or a mode) of the Z coordinates of the plurality of pieces of point data is substituted into the Z coordinates of the cell 10. Hereinafter, “three-dimensional data acquired by the acquisition unit 3 at a time tX” is also simply referred to as “three-dimensional data at a time tX”.

Next, the deformation detection unit 4 acquires the Z coordinate of each cell 10, based on the three-dimensional data at a time t1. Then, the deformation detection unit 4 acquires a difference ΔZ by subtracting the Z coordinate at the time t0 from the Z coordinate at the time t1, for each cell 10. In FIG. 3, the difference ΔZ for each cell 10 is described in unit of centimeter in the associated cell 10. Therefore, for example, the difference ΔZ of the cell 10 in the fourth on an X-axis and the fifth on a Y-axis is plus 15 centimeters. Hereinafter, for convenience of description, “the cell 10 in the fourth on the X-axis and the fifth on the Y-axis” is simply referred to as the cell 10(4,5), and the difference ΔZ of the cell 10(4,5) is also simply referred to as the “difference ΔZ(4,5)”. A matter that the difference ΔZ(4,5) is plus 15 centimeters means that the cell 10 in the fourth on the X-axis and the fifth on the Y-axis is elevated by 15 centimeters by the time t1 on the basis of the time t0. The elevation of the ground 2 does not occur stepwise on the time axis, but generally gradually grows. Therefore, in the present example embodiment, “a deformation has occurred” means that “an elevation being equal to or more than 14 centimeters has occurred on the basis of the time t0” or that “an elevation has grown equal to or more than 14 centimeters on the basis of the time t0”. In other words, in the example in FIG. 3, it can be said that a deformation occurs in the cell 10(4,5) at the time t1.

However, as illustrated in FIG. 3, it is rare that the elevation occurs in such a way as to fit in one cell 10, and the elevation usually occurs in such a way as to be distributed across a plurality of cells 10 in front, back, left, and right. Therefore, as illustrated in FIG. 3, an occurrence position 11g of a deformation 11 occurring at the time t1 may be determined not as a coordinate position of the cell 10(4,5) but as a position of the center of gravity of the elevation occurring by being distributed in the front, back, left, and right around the cell 10(4,5). The position of the center of gravity of the elevation can be calculated by a weighted average acquired by weighting an XY coordinates of the plurality of cells 10 with the elevation of each cell.

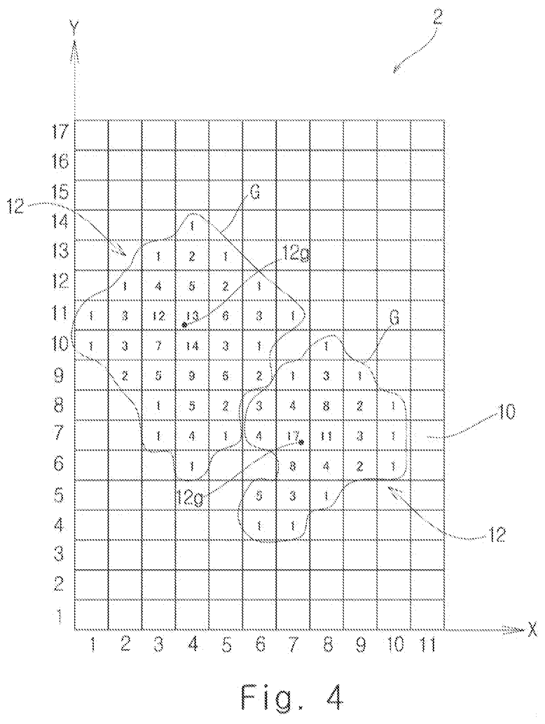

Next, the deformation detection unit 4 acquires the Z coordinate of each cell 10, based on three-dimensional data at a time t2. Then, the deformation detection unit 4 acquires the difference ΔZ by subtracting the Z coordinate at the time t1 from the Z coordinate at the time t2, for each cell 10. In FIG. 4, the difference ΔZ for each cell 10 is described in unit of centimeter in the associated cell 10. As illustrated in FIG. 4, at the time t2, two deformations 12 have been observed at positions away from each other. In other words, at the time t2, two elevation peaks that are distinguishable from each other have been observed. This suggests that the deformation 11 illustrated in FIG. 3 was spread in two separate groups. Therefore, the deformation detection unit 4 first classifies distribution data of the difference ΔZ illustrated in FIG. 4 into two groups G by clustering. Clustering is typically performed by a k-means method. In addition, an elbow method or a silhouette analysis is typically used to determine the number of clusters in clustering.

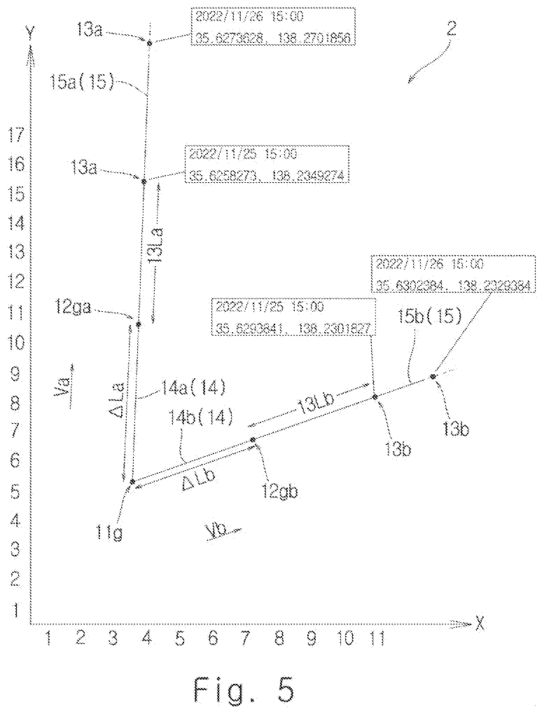

Next, the deformation detection unit 4 calculates an occurrence position 12g of a deformation 12 for each group G. As a method of calculating the occurrence position 12g, the above-described weighted average can be used. The occurrence positions 12g of the two deformations 12 determined in this way are illustrated in FIG. 4. FIG. 5 illustrates the occurrence position 11g of the deformation 11 detected by the deformation detection unit 4 at the time t1, and the occurrence positions 12g of the two deformations 12 detected by the deformation detection unit 4 at the time t2. Hereinafter, for convenience of description, each of the occurrence positions 12g of the two deformations 12 is referred to as an occurrence position 12ga and an occurrence position 12gb.

Next, the deformation prediction unit 5 predicts that a new deformation 13 occurs on an extension line 15 of two line segments 14 connecting the occurrence position 11g and each of the two occurrence positions 12g. In other words, the deformation prediction unit 5 defines an extension line 15a by extending a line segment 14a connecting the occurrence position 11g and the occurrence position 12ga in a direction from the occurrence position 11g toward the occurrence position 12ga. Similarly, the deformation prediction unit 5 defines an extension line 15b by extending a line segment 14b connecting the occurrence position 11g and the occurrence position 12gb in a direction from the occurrence position 11g toward the occurrence position 12gb. Then, the deformation prediction unit 5 predicts that the new deformation 13 will occur in the future on the extension line 15a and the extension line 15b.

Further, the deformation prediction unit 5 calculates deformation propagation velocity Va, based on a spatial difference ΔLa between the occurrence position 11g of the deformation 11 and the occurrence position 12ga of the deformation 12, and a time difference Δt between an occurrence time t1 of the deformation 11 and an occurrence time t2 of the deformation 12. The deformation propagation velocity Va is velocity of a deformation propagating from the occurrence position 11g toward the occurrence position 12ga. Similarly, the deformation prediction unit 5 calculates deformation propagation velocity Vb, based on a spatial difference ΔLb between the occurrence position 11g of the deformation 11 and the occurrence position 12gb of the deformation 12, and a time difference Δt between the occurrence time t1 of the deformation 11 and the occurrence time t2 of the deformation 12. The deformation propagation velocity Vb is velocity of a deformation propagating from the occurrence position 11g toward the occurrence position 12gb. Note that, the deformation propagation velocity Va and the deformation propagation velocity Vb can be acquired by dividing the spatial difference by the time difference. The deformation propagation velocity Va and the deformation propagation velocity Vb are typically different velocity from each other.

Then, the deformation prediction unit 5 predicts, based on the occurrence time t2, the occurrence position 12ga, and the deformation propagation velocity Va, an occurrence time and an occurrence position of a deformation 13a newly occurred on the extension line 15a. In other words, the deformation prediction unit 5 predicts that the deformation 13a newly occurred on the extension line 15a occurs at a position away from the occurrence position 12ga by a distance 13La acquired by multiplying the time difference between the occurrence time of the deformation 13a and the occurrence time t2 by the deformation propagation velocity Va.

Similarly, the deformation prediction unit 5 predicts, based on the occurrence time t2, the occurrence position 12gb, and the deformation propagation velocity Vb, an occurrence time and an occurrence position of a deformation 13b newly occurred on the extension line 15b. In other words, the deformation prediction unit 5 predicts that the deformation 13b newly occurred on the extension line 15b occurs at a position away from the occurrence position 12gb by a distance 13Lb acquired by multiplying the time difference between the occurrence time of the deformation 13b and the occurrence time t2 by the deformation propagation velocity Vb.

As described above, since the deformation prediction unit 5 can predict when and where a new deformation 13 occurs, preparation for the deformation 13 can be started before the deformation 13 occurs.

The output unit 6 typically outputs a deformation propagation diagram illustrated in FIG. 5 to the LCD 1e in an image format. In the deformation propagation diagram illustrated in FIG. 5, the occurrence time and the occurrence position of the deformation 13 predicted by the deformation prediction unit 5 are displayed in association with each other.

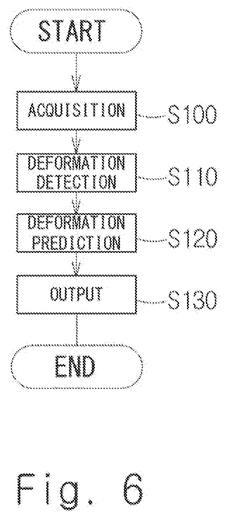

FIG. 6 illustrates an operation flow of the prediction apparatus 1. As illustrated in FIG. 6, the acquisition unit 3 repeatedly acquires three-dimensional data of the ground 2 on the time axis (S100). Next, the deformation detection unit 4 detects a deformation in the ground 2, based on a plurality of pieces of the three-dimensional data (S110). Next, the deformation prediction unit 5 predicts a new deformation that may occur in the future, based on a detection result of the deformation detection unit 4 (S120). Then, the output unit 6 outputs a prediction result by the deformation prediction unit 5 to the LCD 1e in the image format (S130).

While the example embodiment of the present disclosure has been described above, the above-described example embodiment has the following features.

As illustrated in FIGS. 1 to 5, the prediction apparatus 1 includes the acquisition unit 3, the deformation detection unit 4, and the deformation prediction unit 5. The acquisition unit 3 repeatedly acquires three-dimensional data of the ground 2 (monitoring target surface) on the time axis. The deformation detection unit 4 detects, based on a plurality of pieces of the three-dimensional data, the deformation 11 (first deformation) occurring at the time t1 (first time), and the deformation 12 (second deformation) occurring at a position different from the occurrence position 11g of the deformation 11 at the time t2 (second time) being after the time t1. The deformation prediction unit 5 predicts, based on a detection result by the deformation detection unit 4, that the deformation 13 (third deformation) will occur in the future at a position different from the occurrence positions of the deformation 11 and the deformation 12. According to the above-described configuration, it is possible to predict a deformation newly occurring in the ground 2.

As illustrated in FIG. 5, the deformation prediction unit 5 predicts that the deformation 13a occurs on the extension line 15a of the line segment 14a connecting the occurrence position 11g (the first occurrence position) of the deformation 11 and the occurrence position 12ga of the deformation 12. According to the above-described configuration, it is possible to accurately predict the occurrence position of the deformation 13a by utilizing a property that occurrence of a deformation propagates linearly.

In addition, the deformation prediction unit 5 predicts a time t3 at which the deformation 13a occurs and a position at which the deformation 13a occurs, based on the time difference Δt between the occurrence time t1 of the deformation 11 and the occurrence time t2 of the deformation 12, and the space difference ΔLa between the occurrence position 11g and the occurrence position 12ga. According to the above-described configuration, it is possible to predict the occurrence time and the occurrence position of the deformation 13a in association with each other.

In addition, the deformation prediction unit 5 calculates the deformation propagation velocity Va, based on the time difference Δt and the space difference ΔLa. The deformation prediction unit 5 predicts the occurrence time and the occurrence position of the deformation 13a, based on the occurrence time t2, the occurrence position 12ga, and the deformation propagation velocity Va. According to the above-described configuration, it is possible to predict the occurrence time and the occurrence position of the deformation 13a with high accuracy by utilizing a property that propagation of a deformation is constant velocity.

In addition, the prediction apparatus 1 includes the output unit 6 (output means) that outputs the occurrence position of the deformation 13 in an image format. According to the above-described configuration, an operator of the prediction apparatus 1 can visually recognize the occurrence position of the deformation 13.

In addition, the prediction apparatus 1 includes the output unit 6 (output means) that outputs the occurrence positions of the deformations 11, 12, and 13 in an image format. According to the above-described configuration, an operator of the prediction apparatus 1 visually contrasts the occurrence position of the deformation 13 with the occurrence positions of the deformation 11 and the deformation 12, and thereby the operator can determine validity of the occurrence position of the deformation 13.

The present invention is not limited to the above-described example embodiment, and can be appropriately modified without departing from the spirit.

For example, the prediction apparatus 1 illustrated in FIG. 2 may be achieved by distributed processing by a plurality of apparatuses, instead of being achieved by a single apparatus. In this case, the plurality of apparatuses may communicate bi-directionally via an Internet line. In addition, a prediction system may be achieved by the plurality of apparatuses.

As illustrated in FIG. 2, the three-dimensional LiDAR scanner 7 is connected to the prediction apparatus 1 via wired communication. Alternatively, however, the three-dimensional LiDAR scanner 7 may be connected to the prediction apparatus 1 via wireless communication. Alternatively, the three-dimensional LiDAR scanner 7 may be configured integrally with the prediction apparatus 1.

In the examples described above, a program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Note that, a device used by the acquisition unit 3 to acquire the three-dimensional data is not limited to a LiDAR scanner (i.e., the three-dimensional LiDAR scanner 7). The device may be a sensor or a scanner capable of acquiring three-dimensional data of a monitoring target surface (e.g., the ground 2), and may be a sensor or a scanner having spatial resolution high enough to detect a deformation in the monitoring target surface. The deformation in the monitoring target surface is more particularly an elevation, a depression, or the like in each of the cells 10. Therefore, the three-dimensional data acquired by the acquisition unit 3 are not limited to the point cloud data. The three-dimensional data may be acquired as surface data, for example.

Note that, a method of detecting a deformation by the deformation detection unit 4 is not limited to the specific example described above. For example, the deformation detection unit 4 may detect a deformation in the following manner.

That is, as described above, the deformation detection unit 4 acquires the Z coordinate of each time (10, t1, t2, . . . ) for each of the cells 10. Next, the deformation detection unit 4 acquires, for each of the cells 10, a difference value ΔZ of the Z coordinate of each time with respect to a reference value Zref (for example, a predetermined value or a Z coordinate of a reference time in an associated cell 10. The reference value may be t0.). As a result, the deformation detection unit 4 generates, for each of the cells 10, time-series data indicating the difference value ΔZ of the Z coordinate of each time with respect to the reference value Zref. Next, the deformation detection unit 4 decides whether an absolute value |ΔZ| of the difference value ΔZ exceeds a predetermined threshold value Zth, by using the generated time-series data for each of the cells 10, and also determines the time when the absolute value exceeds the predetermined threshold value Zth. As a result, presence or absence of occurrence of a deformation in each of the cells 10, and the time thereof are detected.

In other words, the deformation detection unit 4 acquires the Z coordinate of each time (t0, t1, t2, . . . ) for each of the cells 10. As a result, the deformation detection unit 4 generates time-series data indicating the Z coordinate of each time for each of the cells 10. Next, for each of the cells 10, the deformation detection unit 4 offsets the generated time-series data, based on a reference value (for example, a predetermined value or the Z coordinate of the reference time in an associated cell 10. The reference time may be t0.). The deformation detection unit 4 decides whether the absolute value of the Z coordinate after offsetting exceeds a predetermined threshold value, by using the time-series data after offsetting for each of the cells 10, and also determines the time when the absolute value exceeds the predetermined threshold value. As a result, presence or absence of occurrence of a deformation in each of the cells 10, and the time thereof are detected.

Note that, a method of predicting a deformation by the deformation prediction unit 5 is not limited to the specific example described above. The deformation prediction unit 5 may predict occurrence of the deformation (13) at a future time (t3), based on a detection result of the deformations (11g, 12g) at a plurality of past times (t0, t1, t2) by the deformation detection unit 4. In other words, the deformation prediction unit 5 may predict the occurrence of the deformation (13) at another position at the future time (t3) by estimating a direction and velocity in which the deformation extends (i.e., a range in which the deformation extends) in the monitoring target surface (e.g., the ground 2).

Note that, the output unit 6 may output an image (hereinafter, sometimes referred to as a “first image”) indicating the detected first deformation (e.g., the deformation 11g at the time t1) when the occurrence of the first deformation is detected by the deformation detection unit 4. In the first image, the occurrence time and the occurrence position of the detected first deformation may be displayed in association with each other. In addition, the first image may include an image indicating a plurality of cells 10 (refer to FIGS. 3 and 4), and a display mode (e.g., color) of the cell 10 in which the first deformation is detected and the display mode (e.g., color) of the other cell 10 may be different from each other.

In addition, instead of or in addition to outputting the first image, the output unit 6 may output an image (hereinafter, sometimes referred to as a “second image”) indicating the detected first deformation and the detected second deformation (e.g., the deformation 12g at the time t2) when the occurrence of the second deformation is detected by the deformation detection unit 4. In the second image, the occurrence time and the occurrence position of the detected first deformation may be displayed in association with each other, and also the occurrence time and the occurrence position of each of the detected second deformations may be displayed in association with each other. In addition, the second image may include an image indicating a plurality of cells 10 (refer to FIGS. 3 and 4), and the display mode (e.g., color) of the cell 10 in which the first deformation is detected, the display mode (e.g., color) of the cell 10 in which the second deformation is detected, and the display mode (e.g., color) of the other cell 10 may be different from one another.

Then, instead of or in addition to displaying at least one of the first image and the second image, the output unit 6 may output an image (hereinafter, sometimes referred to as a “third image”) indicating the detected first deformation, the detected second deformation, and the predicted third deformation (e.g., the deformation 13 at the time t3) when the occurrence of the third deformation is predicted by the deformation prediction unit 5. In the third image, similar to the deformation propagation diagram illustrated in FIG. 5, the occurrence time and the occurrence position of each of the predicted third deformations may be displayed in association with each other. In addition, in the third image, the occurrence time and the occurrence position of the detected first deformation may be displayed in association with each other, and also the occurrence time and the occurrence position of each of the detected second deformations may be displayed in association with each other. In addition, the third image may include an image indicating a plurality of cells 10 (refer to FIGS. 3 and 4), and the display mode (e.g., color) of the cell 10 in which the first deformation is detected, the display mode (e.g., color) of the cell 10 in which the second deformation is detected, the display mode (e.g., color) of the cell 10 in which the third deformation is predicted, and the display mode (e.g., color) of the other cell 10 may be different from one another.

Herein, in the third image, a plurality of contour-like curved lines indicating a temporal change in a position and a shape of an occurrence region of a deformation in the monitoring target surface may be displayed based on the occurrence time and the occurrence position of the first deformation, the occurrence time and the occurrence position of the second deformation, and the occurrence time and the occurrence position of the third deformation. That is, each of the plurality of curved lines is, for example, a line-segment-like or elliptical curved line associated to each of a plurality of the times (t1, t2, t3, . . . . Each of the curved lines may be, for example, a curved line passing through a predetermined portion (e.g., a center portion) of each of the plurality of cells 10 when occurrence of a deformation in the plurality of cells 10 is detected or predicted at an associated time. Alternatively, for example, when a plurality of line segments (14) and a plurality of extension lines (15) are set by the deformation prediction unit 5, each of the curved lines may be a curved line passing through a portion associated to an associated time in each of the plurality of line segments or each of the plurality of extension lines.

In addition, in the third image, in addition to displaying the plurality of contour-like curved lines, a plurality of line segments (14) and a plurality of extension lines (15) set by the deformation prediction unit 5 may be displayed. In this case, there is high probability that each of the line segments (14) and the associated extension lines (15) become straight lines that pass through a portion where a line interval in the contour lines is wide. As a result, a user can visually more easily recognize the direction and velocity at which a deformation extends.

In addition, the deformation prediction unit 5 may predict occurrence of a deformation (third deformation) by using a plurality of contour-like curved lines, based on a result of detection by the deformation detection unit 4. Specifically, for example, the deformation prediction unit 5 may predict the occurrence of the deformation (third deformation) in the following manner.

That is, the deformation prediction unit 5 sets, for each of the plurality of times (including t1 and t2), a curved line passing through a position (e.g., a position of the cell 10 where ΔZ exceeds a predetermined value) of a point where a deformation occurs at the time, based on a result of the detection by the deformation detection unit 4. As a result, a plurality of contour-like curved lines are set. Each of the plurality of curved lines is, for example, a line-segment-like or elliptical curved line associated to each of a plurality of the times (t1, t2, . . . ).

Next, the deformation prediction unit 5 detects a portion where a line interval in the contour lines is wider than that of the other portions. In other words, the deformation prediction unit 5 detects a portion where the line interval is widened in the contour lines. For example, when cause of an elevation or a depression in the ground 2 is excavation work by a shield machine under the ground, the detected portion is highly likely to be arranged in a straight line. Therefore, the deformation prediction unit 5 sets a straight line passing through the detected portion. The deformation prediction unit 5 predicts that a position (e.g., the cell 10 through which the set straight line passes) at which the set straight line passes on the monitoring target surface is the occurrence position of the third deformation. In addition, the deformation prediction unit 5 calculates deformation propagation velocity V, based on the line interval of the contour lines in the detected portion.

In this case, the output unit 6 may display an image including the plurality of contour-like curved lines set by the deformation prediction unit 5, and including the straight line set by the deformation prediction unit 5. As a result, as in a case of displaying the third image, a user can visually more easily recognize the direction and velocity at which the deformation extends.

The whole or part of the example embodiment described above can be described as, but not limited to, the following supplementary notes.

### (Supplementary Note 1)

A prediction system including:
an acquisition means for repeatedly acquiring three-dimensional data of a monitoring target surface on a time axis;
a deformation detection means for detecting, based on a plurality of pieces of the three-dimensional data, a first deformation occurring at a first time, and a second deformation occurring at a position different from an occurrence position of the first deformation at a second time being after the first time; and
a deformation prediction means for predicting, based on a detection result by the deformation detection means, that a third deformation occurs in a future at a position different from occurrence positions of the first deformation and the second deformation.

### (Supplementary Note 2)

The prediction system according to supplementary note 1, wherein the deformation prediction means predicts that the third deformation occurs on an extension line of a line segment connecting a first occurrence position as an occurrence position of the first deformation and a second occurrence position as an occurrence position of the second deformation.

### (Supplementary Note 3)

The prediction system according to supplementary note 2, wherein the deformation prediction means predicts a third time as a time at which the third deformation occurs and a third occurrence position as a position at which the third deformation occurs, based on a time difference between the first time and the second time, and a spatial difference between the first occurrence position and the second occurrence position.

### (Supplementary Note 4)

The prediction system according to supplementary note 3, wherein the deformation prediction means calculates deformation propagation velocity, based on the time difference and the spatial difference, and predicts the third time and the third occurrence position, based on the second time, the second occurrence position, and the deformation propagation velocity.

### (Supplementary Note 5)

The prediction system according to supplementary note 3 or 4, further including an output means for outputting the third occurrence position in an image format.

### (Supplementary Note 6)

The prediction system according to supplementary note 3 or 4, further including an output means for outputting the first occurrence position, the second occurrence position, and the third occurrence position in an image format.

### (Supplementary Note 7)

The prediction system according to any one of supplementary notes 1 to 4, wherein the three-dimensional data are point cloud data being output from a three-dimensional LiDAR scanner.

### (Supplementary Note 8)

A prediction apparatus including:
an acquisition means for repeatedly acquiring three-dimensional data of a monitoring target surface on a time axis;
a deformation detection means for detecting, based on a plurality of pieces of the three-dimensional data, a first deformation occurring at a first time, and a second deformation occurring at a position different from an occurrence position of the first deformation at a second time being after the first time; and
a deformation prediction means for predicting, based on a detection result by the deformation detection means, that a third deformation occurs in a future at a position different from occurrence positions of the first deformation and the second deformation.

### (Supplementary Note 9)

The prediction apparatus according to supplementary note 8, wherein the deformation prediction means predicts that the third deformation occurs on an extension line of a line segment connecting a first occurrence position as an occurrence position of the first deformation and a second occurrence position as an occurrence position of the second deformation.

### (Supplementary Note 10)

The prediction apparatus according to supplementary note 9, wherein the deformation prediction means predicts a third time as a time at which the third deformation occurs and a third occurrence position as a position at which the third deformation occurs, based on a time difference between the first time and the second time, and a spatial difference between the first occurrence position and the second occurrence position.

### (Supplementary Note 11)

The prediction apparatus according to supplementary note 10, wherein the deformation prediction means calculates deformation propagation velocity, based on the time difference and the spatial difference, and predicts the third time and the third occurrence position, based on the second time, the second occurrence position, and the deformation propagation velocity.

### (Supplementary Note 12)

The prediction apparatus according to supplementary note 10 or 11, further including an output means for outputting the third occurrence position in an image format.

### (Supplementary Note 13)

The prediction apparatus according to supplementary note 10 or 11, further including an output means for outputting the first occurrence position, the second occurrence position, and the third occurrence position in an image format.

### (Supplementary Note 14)

The prediction apparatus according to any one of supplementary notes 8 to 11, wherein the three-dimensional data are point cloud data being output from a three-dimensional LiDAR scanner.

### (Supplementary Note 15)

A prediction method including,
by a computer executing:
an acquisition step of repeatedly acquiring three-dimensional data of a monitoring target surface on a time axis;
a deformation detection step of detecting, based on a plurality of pieces of the three-dimensional data, a first deformation occurring at a first time, and a second deformation occurring at a position different from an occurrence position of the first deformation at a second time being after the first time; and
a deformation prediction step of predicting, based on a detection result in the deformation detection step, that a third deformation occurs in a future at a position different from occurrence positions of the first deformation and the second deformation.

### (Supplementary Note 16)

The prediction method according to supplementary note 15, further including, in the deformation prediction step, predicting that the third deformation occurs on an extension line of a line segment connecting a first occurrence position as an occurrence position of the first deformation and a second occurrence position as an occurrence position of the second deformation.

### (Supplementary Note 17)

The prediction method according to supplementary note 16, further including, in the deformation prediction step, predicting a third time as a time at which the third deformation occurs and a third occurrence position as a position at which the third deformation occurs, based on a time difference between the first time and the second time, and a spatial difference between the first occurrence position and the second occurrence position.

### (Supplementary Note 18)

The prediction method according to supplementary note 17, further including, in the deformation prediction step:
calculating deformation propagation velocity, based on the time difference and the space difference; and
predicting the third time and the third occurrence position, based on the second time, the second occurrence position, and the deformation propagation velocity.

### (Supplementary Note 19)

The prediction method according to supplementary note 17 or 18, further including, by the computer executing, an output step of outputting the third occurrence position in an image format.

### (Supplementary Note 20)

The prediction method according to supplementary note 17 or 18, further including, by the computer executing, an output step of outputting the first occurrence position, the second occurrence position, and the third occurrence position in an image format.

### (Supplementary Note 21)

The prediction method according to any one of supplementary notes 15 to 18, wherein the three-dimensional data are point cloud data being output from a three-dimensional LiDAR scanner.

### (Supplementary Note 22)

A program causing a computer to function as:
an acquisition means for repeatedly acquiring three-dimensional data of a monitoring target surface on a time axis;
a deformation detection means for detecting, based on a plurality of pieces of the three-dimensional data, a first deformation occurring at a first time, and a second deformation occurring at a position different from an occurrence position of the first deformation at a second time being after the first time; and
a deformation prediction means for predicting, based on a detection result by the deformation detection means, that a third deformation occurs in a future at a position different from occurrence positions of the first deformation and the second deformation.

### (Supplementary Note 23)

The program according to supplementary note 22, wherein the deformation prediction means predicts that the third deformation occurs on an extension line of a line segment connecting a first occurrence position as an occurrence position of the first deformation and a second occurrence position as an occurrence position of the second deformation.

### (Supplementary Note 24)

The program according to supplementary note 23, wherein the deformation prediction means predicts a third time as a time at which the third deformation occurs and a third occurrence position as a position at which the third deformation occurs, based on a time difference between the first time and the second time, and a spatial difference between the first occurrence position and the second occurrence position.

### (Supplementary Note 25)

The program according to supplementary note 24, wherein the deformation prediction means calculates deformation propagation velocity, based on the time difference and the space difference, and predicts the third time and the third occurrence position, based on the second time, the second occurrence position, and the deformation propagation velocity.

### (Supplementary Note 26)

The program according to supplementary note 24 or 25, further causing the computer to function as an output means for outputting the third occurrence position in an image format.

### (Supplementary Note 27)

The program according to supplementary note 24 or 25, further causing the computer to function as an output means for outputting the first occurrence position, the second occurrence position, and the third occurrence position in an image format.

### (Supplementary Note 28)

The program according to any one of supplementary notes 22 to 25, wherein the three-dimensional data are point cloud data being output from a three-dimensional LiDAR scanner.

According to the present disclosure, it is possible to predict a deformation in a monitoring target surface.

The first and second example embodiments can be combined as desirable by one of ordinary skill in the art.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

What is claimed is:

1. A prediction system comprising:
at least one memory storing instructions, and
at least one processor configured to execute the instructions to;
repeatedly acquire three-dimensional data of a monitoring target surface on a time axis;
detect, based on a plurality of pieces of the three-dimensional data, a first deformation occurring at a first time, and a second deformation occurring at a position different from an occurrence position of the first deformation at a second time being after the first time; and
predict, based on a detection result, that a third deformation occurs in a future at a position different from occurrence positions of the first deformation and the second deformation.

2. The prediction system according to claim 1, wherein the at least one processor is further configured to execute the instructions to predict that the third deformation occurs on an extension line of a line segment connecting a first occurrence position as an occurrence position of the first deformation and a second occurrence position as an occurrence position of the second deformation.

3. The prediction system according to claim 2, wherein the at least one processor is further configured to execute the instructions to predict a third time as a time at which the third deformation occurs and a third occurrence position as a position at which the third deformation occurs, based on a time difference between the first time and the second time, and a spatial difference between the first occurrence position and the second occurrence position.

4. The prediction system according to claim 3, wherein the at least one processor is further configured to execute the instructions to calculate deformation propagation velocity, based on the time difference and the spatial difference, and predict the third time and the third occurrence position, based on the second time, the second occurrence position, and the deformation propagation velocity.

5. The prediction system according to claim 3, wherein the at least one processor is further configured to execute the instructions to output the third occurrence position in an image format.

6. The prediction system according to claim 3, the at least one processor is further configured to execute the instructions to output the first occurrence position, the second occurrence position, and the third occurrence position in an image format.

7. The prediction system according to claim 1, wherein the three-dimensional data are point cloud data being output from a three-dimensional LiDAR scanner.

8. A prediction apparatus comprising:
at least one memory storing instructions, and
at least one processor configured to execute the instructions to;
repeatedly acquire three-dimensional data of a monitoring target surface on a time axis;
detect, based on a plurality of pieces of the three-dimensional data, a first deformation occurring at a first time, and a second deformation occurring at a position different from an occurrence position of the first deformation at a second time being after the first time; and
predict, based on a detection result, that a third deformation occurs in a future at a position different from occurrence positions of the first deformation and the second deformation.

9. The prediction apparatus according to claim 8, wherein the at least one processor is further configured to execute the instructions to predict that the third deformation occurs on an extension line of a line segment connecting a first occurrence position as an occurrence position of the first deformation and a second occurrence position as an occurrence position of the second deformation.

10. The prediction apparatus according to claim 9, wherein the at least one processor is further configured to execute the instructions to predict a third time as a time at which the third deformation occurs and a third occurrence position as a position at which the third deformation occurs, based on a time difference between the first time and the second time, and a spatial difference between the first occurrence position and the second occurrence position.

11. The prediction apparatus according to claim 10, wherein the at least one processor is further configured to execute the instructions to calculate deformation propagation velocity, based on the time difference and the spatial difference, and predict the third time and the third occurrence position, based on the second time, the second occurrence position, and the deformation propagation velocity.

12. The prediction apparatus according to claim 10, wherein the at least one processor is further configured to execute the instructions to output the third occurrence position in an image format.

13. The prediction apparatus according to claim 10, the at least one processor is further configured to execute the instructions to output the first occurrence position, the second occurrence position, and the third occurrence position in an image format.

14. The prediction apparatus according to claim 8, wherein the three-dimensional data are point cloud data being output from a three-dimensional LiDAR scanner.

15. A prediction method comprising,
repeatedly acquiring three-dimensional data of a monitoring target surface on a time axis;
detecting, based on a plurality of pieces of the three-dimensional data, a first deformation occurring at a first time, and a second deformation occurring at a position different from an occurrence position of the first deformation at a second time being after the first time; and
predicting, based on a detection result, that a third deformation occurs in a future at a position different from occurrence positions of the first deformation and the second deformation.

16. The prediction method according to claim 15,
in the predicting, further comprises predicting that the third deformation occurs on an extension line of a line segment connecting a first occurrence position as an occurrence position of the first deformation and a second occurrence position as an occurrence position of the second deformation.

17. The prediction method according to claim 16,
in the predicting, further comprises predicting a third time as a time at which the third deformation occurs and a third occurrence position as a position at which the third deformation occurs, based on a time difference between the first time and the second time, and a spatial difference between the first occurrence position and the second occurrence position.

18. The prediction method according to claim 17, in the predicting, further comprises;
calculating deformation propagation velocity, based on the time difference and the space difference; and
predicting the third time and the third occurrence position, based on the second time, the second occurrence position, and the deformation propagation velocity.

19. The prediction method according to claim 17, further comprising outputting the third occurrence position in an image format.

20. The prediction method according to claim 17, further comprising outputting the first occurrence position, the second occurrence position, and the third occurrence position in an image format.
